(19) United States
(12) Patent Application Publication
(10) Pub. No.: US 2026/0197559 A1
(43) Pub. Date: Jul. 9, 2026

(54) ILLUMINATION ADAPTING METHOD AND PICTURE RECORDING ARRANGEMENT

(71) Applicant: ams-OSRAM AG, Premstätten (AT)

(72) Inventors: Raoul Mallart, Paris (FR); Josselin Manceau, Bagneux (FR); Enrico Cortese, Paris (FR); Guillaume Cortes, Villeurbanne (FR); Matis Hudon, Charenton-le-Pont (FR)

(21) Appl. No.: 18/868,291

(22) PCT Filed: May 3, 2023
(86) PCT No.: PCT/EP2023/061613

§ 371 Date: Nov. 22, 2024

(30) Foreign Application Priority Data
Jun. 3, 2022 (DE) 10 2022 114 106.3

(51) Int. Cl. H04N 23/74; H04N 23/71; H04N 23/72; H04N 23/76

(52) U.S. Cl. CPC H04N 23/74; H04N 23/71; H04N 23/72; H04N 23/76

(57) ABSTRACT

In an embodiment, a method includes A) providing a picture recording arrangement comprising an image sensor and a light source, the light source being configured to illuminate a scene comprising a target along different emission directions, B) taking at least one calibration picture for each one of the emission directions, wherein, per calibration picture, the light source emits radiation only along a subset of the emission directions, C) generating an optimized weight vector by minimizing an objective function, the optimized weight vector including at least one intensity value for each one of the emission directions and D) taking at least one target image of the target by controlling light emission of the light source along the emission directions according to the optimized weight vector, wherein, in step D), the target is illuminated in an indirect manner so that at least some of the emission directions point next to the target and not onto the target, and wherein a diameter of the light source is at most 0.3 m, seen in top view of the images sensor.

### CROSS-REFERENCE TO RELATED APPLICATIONS

This patent application is a national phase filing under section 371 of PCT/EP2023/061613, filed May 3, 2023, which claims the priority of German patent application 102022114106.3, filed Jun. 3, 2022, each of which is incorporated herein by reference in its entirety.

### TECHNICAL FIELD

A method for adapting illumination and a picture recording arrangement are provided.

### BACKGROUND

Document JP 2022-003 372 A refers to a rotating flash unit.

Document Hao Zhou et al., “Deep Single-Image Portrait Relighting” in International Conference on Computer Vision (ICCV), 2019, refers to image relighting.

### SUMMARY

Embodiments provide a picture recording arrangement and a corresponding method for improved image quality.

With the method and the picture recording arrangement described herein, for example, indirect illumination of a target to be imaged is used, and directions from which the indirect illumination comes from are adjusted by emitting a defined light pattern next to the target by controlling an adjustable photo flash which is realized in particular by a multi-LED light source.

According to at least one embodiment, the method is for adapting illumination. For example, by the method a photo flash is provided for taking images. The at least one image to be taken can be a single picture or can also be a series of pictures, like an animated image or a video.

According to at least one embodiment, the method includes the step of providing a picture recording arrangement. The picture recording arrangement comprises one or a plurality of image sensors, like CCD sensors. Further, the picture recording arrangement comprises one or a plurality of light sources, like an LED light source. The at least one light source is configured to illuminate a scene comprising a target to be photographed along different emission directions. In other words, the at least one light source is configured to provide a plurality of illuminated areas, for example, in surroundings of the target.

The term ‘light source’ may refer to visible light, like white light or red, green and/or blue light, but can also include infrared radiation, for example, near-infrared radiation in the spectral range from 750 nm to 1.2 μm. That is, along each emission direction visible light and/or infrared radiation can be emitted.

According to at least one embodiment, the method includes the step of taking at least one calibration picture for each one of the emission directions, wherein per calibration picture the light source emits radiation only along a subset of the emission directions. The calibration pictures can be taken by visible light or alternatively by using infrared radiation.

For example, N calibration pictures are taken for the M emission directions, wherein N and M are natural numbers, for example, larger than or equal to two or larger than or equal to six or larger than or equal to ten. Alternatively or additionally, N and M are smaller than or equal to 40 or smaller than or equal to 30 or smaller than or equal to 20. It is possible that N=M, but it is also possible that |M-N|≠0, for example, 0<|M-N|≤3 or 0<|M-N|≤0.25 max {M; N} or 0<|M-N|≤max {M; N}.

For example, the subset of emission directions consists in each case of one of the emission directions. However, it is also possible that the subset of emission directions includes more than one of the emission directions, for example, two or three or four of the emission directions. It is possible that all the calibration pictures are taken with the same number of emission directions activated, that is, with an equal size of subsets, or that the calibration pictures are taken with different number of activated directions, that is, with subsets of different sizes. In particular, the emission directions are different from each other in pairs so that there are no emission directions being parallel or congruent with each other.

However, preferably, N=M, and there are M linear independent subsets of emission directions, and there is one or there are two emission directions per subset, and all the subsets are of equal size, that is, comprising the same number of emission directions.

According to at least one embodiment, the method includes the step of generating an optimized weight vector by minimizing an objective function, the optimized weight vector includes at least one intensity value for each one of the emission directions. For example, the objective function is a loss function. The objective function can be a quadratic function, for example, when using least square techniques. The objective function can be based on a metric, like an L2 norm or also referred to as Euclidean distance.

It is possible that the weight vector is a row vector or also a column vector, depending on its use. In particular, a dimension of the vector is M or p times M wherein p is a natural number, in particular, p∈{1; 2; 3; 4}. For example, the objective function can be a function expressing a difference between a desired picture design or illumination pattern and a linear combination of the calibration pictures, and the optimized weight vector is in particular that vector which, when multiplied with a calibration vector composed of the N calibration pictures and resulting in a composite image, provides the smallest difference between the composite image and the desired picture design or illumination pattern.

According to at least one embodiment, the method includes the step of taking one or a plurality of target images of the target by controlling light emission of the light source along the emission directions according to the optimized weight vector. In other words, a light intensity of each one of the emission directions, or of a light-emitting unit of the light source corresponding to the respective emission direction, is encoded by the assigned intensity value of the optimized weight vector.

In at least one embodiment, the method is for adapting illumination and comprises the following steps, for example, in the stated order:
A) Providing a picture recording arrangement comprising an image sensor and a light source, the light source is configured to illuminate a scene comprising a target along different emission directions,
B) Taking at least one calibration picture for each one of the emission directions, wherein per calibration picture the light source emits radiation only along a subset of the emission directions,
C) Generating an optimized weight vector by minimizing an objective function, the optimized weight vector includes at least one intensity value for each one of the emission directions, and
D) Taking at least one target image of the target by controlling light emission of the light source along the emission directions according to the optimized weight vector, wherein, for example, in step D) the target is illuminated in an indirect manner so that at least some of the emission directions point next to the target and not onto the target, and, for example, alternatively or additionally a diameter of the light source is at most 0.3 m, seen in top view of the images sensor.

In other words, for example, a method is provided to control a group of light-emitting units of a light source to match a target light distribution while illuminating a scene, using pre-captured images with each light-emitting unit individually turned on as an input.

Cameras in mobile devices, like smart phones, are very small, and cannot receive a big amount of light and therefore behave poorly in low-light environment, producing images with a lot of noise. To get a good image exposition, it is common to try to add artificial lighting to the scene, by turning on some artificial light sources during image capture. The nature of this additional light can have a huge impact on the quality of the final picture, and the method described herein provides a solution to improve the way flash LEDs can bring light into a low-light scene. The method focuses on improving the quality of artificial flash for indoor environments.

One possibility to solve the problem of low-light photography is to take several images in a burst and merge them together using motion adaptation techniques in order to reduce the amount of motion blur. However, this solution is limited by the fact that it acquires images during several seconds and tries to merge them together, and is therefore prone to motion blur when taking pictures of moving objects.

Another possibility relies on very high ISO capabilities. Other image sensors are generally optimized for low ISO. Very high ISO generates a lot of noise, but noise reduction can be used. Although this solution is promising, the heavy denoising algorithms necessary to compensate for this very high ISO tend to clear out the details in the image.

The more standard and historical approach to the low-light problem is to use a flash to illuminate the scene. There are two main use cases for flashes in photography:
In some cases, it is possible to use external light sources that can be configured exactly as needed. Those sources often provide indirect lighting, that is light bouncing on a reflective surface and running then to the target to be photographed, or go through diffusers to avoid sharp shadows. This use case mainly concerns professional photographers who shoot in a studio as a controlled environment.
Sometimes, there is no control over the environment and the light source must remain very close to the camera, for example, in smart phones or small cameras. Therefore, the flash sends direct light to the scene, that is, there is a straight line between the light source and the photographed target, creating many problems such as strong reflections, bad shading, overexposure of close targets and/or sharp shadows. Further, subjects may be dazzled by direct light.

In the latter specific use case, there are some possibilities to reduce the afore-mentioned problems:
A depth and RGB camera can be used to analyze the scene with a first RGBD capture, then use a video projector to flash spatially distributed light, providing a better lighting of the background and avoiding overexposure of foreground objects.
Several LEDs of different colors covering the whole spectrum can be used. By analyzing the spectral distribution with a first picture without flash, and then controlling the LEDs to flash a light that either matches or compensates the initial distribution, an ambient mood can be preserved or an active white balance correction can be provided.
A standard flash unit can be mounted on a mobile structure attached to a digital single-lens reflex, DSLR, camera. By applying an algorithm that uses additional depth sensors and fisheye camera to analyze the scene, the best direction for the mobile flash can be derived.

In the method described herein, a picture recording arrangement is used that contains a set of, for example, M independently controlled light-emitting units, all close to the camera but each pointing in a different direction. A process or an algorithm is used that optimizes the intensity applied to each light-emitting unit during the flash. The weight applied to each light-emitting unit can be optimized according to different criteria.

The light-emitting units should be oriented so that the amount of light that directly enters the field of view of the camera, that is, of the image sensor, is as low as possible. Thus, direct light of standard flashes is replaced by indirect light, that bounces on a nearby surface in surroundings of the object to be photographed. For example, useful emission directions are oriented with an angle of about 60° with relation to the main optical axis and have a beam angle of around 25°.

The method optimizes the intensity of each of the, for example, M light sources, by finding an optimal vector _{∧} of p times M weights, also referred to as λ, and for each λ it applies: λ∈[0; 1], to be applied to the light-emitting units. A weight of zero means that the corresponding light-emitting unit is turned off and a weight of one means the corresponding light-emitting unit is at full power.

The optimal intensities to be used can be found with the following steps, for example:
Take one picture per light-emitting unit or emission direction, in which only the corresponding light-emitting unit is turned on and the others are turned off.
Compute a linear combination image IC=I_{∧} from this set of images. An optimal linear combination of intensities to be applied to the light-emitting units can be found by finding a weight vector ∧ that minimizes the defined objective function f, depending on the targeted application: argmin_{∧} f(I_{∧}). Any mathematical optimization algorithm can be used to find the optimal weight vector ∧, for example, a gradient descent-based algorithm can be used.
Once the optimal weight vector ∧ has been found, the weights λ are applied to the light-emitting units and a new image is shot. This allows to get a final picture with very low motion blur and artifacts, compared to the numerical fusion of all the individual calibration pictures taken before.

In the described algorithm, the weights λ can have, for example, any value between 0.0, that is, light turned off, and 1.0, that is, light turned on with maximum intensity. This scale is continuous, and every weight can take a virtually infinite number of values. It is even more true for the weight vector ∧ that contains many of the weight values λ. The number of combinations is virtually infinite and the algorithm to optimize the vector can thus be comparably complex.

One could also imagine a system where the intensity of each light-emitting unit can only be chosen from a limited, finite set of values, like {0.0; 0.5; 1.0}. In this case, the number of combinations is finite. For example, for ten light-emitting units with only three possible intensities, the total number of possibilities is 3¹⁰=59049. One could then imagine a different type of algorithm, for example, a brute force algorithm testing all possibilities, to optimize the weights λ.

Depending on the application, an objective function, like a loss function, to be optimized can be chosen. Two examples of such applications are:

### Ambient Light Preservation

It is tried to illuminate the scene while preserving the ambient light and the visual mood from the low-light environment. Most of the time, even without artificial light, the scene is still weakly illuminated. The human eye is very good at adapting to low luminosity, and it is expected to take a picture that reproduces the world as the human eye saw it, that is, with the same light distribution but with good exposure.

To match ambient light, a loss function like in the following is built:
Take a low-light picture which is very dark.
Apply a numerical boost to reach the target exposure. The result will be very noisy as the image sensor is not good enough to capture low-light images accurately.
Compute the L2 norm between the luminance channels of the low-light boosted Docket No. OSR-980-EH-8- Substitute Specification-image and the composited image. The composited image is the one obtained by numerically combining all individual calibration pictures. The output of the L2 norm is the output of the loss function.

### Style Transfer

In this case it is tried to transfer the style of an arbitrarily chosen image to the final picture to be shot, by actively optimizing the flash. In this use case, it is considered that the color of the light emitted by each light-emitting unit can preferably also be independently controlled. Because in this case the light is preferably color-controlled, the weight vector ∧ to be optimized is three times bigger. It contains intensity values for each color channel, that is, for red, green and blue, RGB for short, instead of one general intensity value.

To apply a style from an external picture to the scene to be photographed, a loss function can be built like this:
From the reference image, compute the spherical harmonic representation of the reference ambient light. This yields a vector representing the harmonic coefficients of the reference light in the LAB color space.
From the composited image, compute the same spherical harmonics representation.
Compute the L2 norm between the two spherical harmonics representations and use it as output of the loss function.

To compute the spherical harmonic representation of an ambient light from an image, a neural network can be used, for example, trained to do such a decomposition. A corresponding method can be found for example, in Hao Zhou et al., “Deep Single-Image Portrait Relighting” in International Conference on Computer Vision (ICCV), 2019, the disclosure content of which is incorporated by reference.

To better understand the advantages of the method described herein, the main problems of flash photography discussed previously are noted again, as they are: strong reflections, bad shading, overexposure, sharp shadows, dazzled subject. Taken in mind that the most popular for low-light mobile photography is currently to not use the flash at all and enhance the picture with night mode algorithms, the associated main disadvantages are: motion blur, artifacts.

In the method described herein, for example, use of two innovations is made. The first one is to use a set of light-emitting units that point in different emission directions, outside the field of view, the second is to control the intensity of those light-emitting units to match a reference illumination.

The use of bouncing light solves many problems of the direct flash. When the light bounces on a surface, it is equivalent to using a by far bigger light source placed on the respective surface; the size of this virtual light being equal to the footprint of the flash on said surface. Using such a light inherently removes strong reflections and sharp shadows.

The light optimization algorithm used is in particular designed to detect bad shading and overexposure caused by certain light sources and decrease their intensity to remove the problem. The fact that a final picture is reshot with the weight vector applied to the light-emitting units means that no artifacts are present, like from heavy denoising, and that motion blur is reduced due to a shorter exposition time.

In summary, use of bouncing light removes strong reflections and sharp shadows, optimization of independent light-emitting units provides better shading and reduces overexposure, and to reshoot the picture without heavy denoising does not lead to any artifacts and reduces motion blur.

For example, the method can be used in the following embodiments and/or applications:
Use in a smartphone for low-light photography

The main embodiment for the method described herein may concern mobile photography. If powerful enough LEDs with required light distribution for bouncing light can be miniaturized and put on the back of a smartphone, it becomes possible to take indoor flash pictures without all the disadvantages of direct artificial light.

### Colored Light

For example, for the style transfer application, another possible embodiment is to have colored light sources. In this case, it is possible to spatially distribute not only the light intensity, but also its spectrum. The control of the color of the light sources can be of different types.

For example, in case of RGB, the exact color of each light-emitting unit can be controlled over a wide range of values that cover the whole spectrum or gamut. In this case, the intensity is controlled by three parameters, for example, one for each channel, like red, blue and green. The algorithm used works exactly the same as indicated above, except it's optimizing a weight vector of three parameters per light-emitting unit instead of one in case of a single-color light source.

For example, in case of correlated color temperature, CCT for short, many light sources, including LEDs, can emit light on a reduced spectrum from “warm” to “cold”. The parameter that defines a light color on this scale is called the “temperature”. Recent mobile phones even propose a “dual-tone” flash that has one cold-white emitting LED and one warm-white emitting LED, and automatically choose a mix of the two in order to emit light at the CCT that best fits a scene.

Such a setting of a “dual-tone” flash can be used for each of the independent light-emitting units of the light source. In this case, the emitted light per emission direction is controlled by two parameters: the intensity and the temperature. The algorithm described above works exactly the same in this scenario, except it's optimizing a weight vector of two parameters per light-emitting unit instead of only one.

### Infrared Lights

The light source could also emit light in the infrared, IR for short, spectral range. In such a system, the camera would also have IR capabilities in order to see the light emitted by the IR source or IR sources. In this case, the intensity of the light-emitting units is optimized just in the same way, and the IR flash picture is then used to denoise the low-light image. When trying to increase numerically the exposure of the low-light image, a lot of noise appears due to the limitations of the sensor. The IR flash picture that has a very good shading, thanks to the optimization described herein, could be used as a guide to denoise this low-light picture without washing out the details, as many denoising algorithms tend to do.

The main advantage with this approach using an IR source is that no visible light comes out of the flash, therefore making it much less disturbing for people in the room and providing a much better user experience.

### Dynamic Visual Effects

Another way of controlling the emitted light is to have dynamic weights and permanent illumination instead of a flash. In order to create a specific mood, for video content creation, for example, the light-emitting units can be controlled dynamically to create visual effects such as standing near a campfire or being underwater. In this use case, the weights are constantly re-evaluated to fit with a target animation.

Further, it is possible to use additional sensors. That is, the number of input parameters to the optimization algorithm can be increased using, for example, information from a depth sensor and/or a wide-angle camera. Information from those sensors would give additional information for a better performing weights optimizer.

In a modification of the method, there is no reshoot. That is, the weights to the light-emitting units are never applied and the composited image is directly used as an output. The composited image is the one that is created by combining the calibration pictures taken with individual light-emitting units on during the gradient descent, for example. In this case, motion blur, for example, if the photographer moves his hand a little during the acquisition process of the calibration pictures, can occur. However, this modified method could be improved, by trying to align the calibration pictures, for example, possibly yielding acceptable results.

According to at least one embodiment, the image sensor and the light source and preferably the target as well are in the same position throughout method steps B) and D). In other words, the picture recording arrangement does not move intentionally during and between steps B) and D).

According to at least one embodiment, in step D) the target is illuminated in an indirect manner so that all or some or a majority of the emission directions point next to the target. In other words, all or some or a majority of the emission directions do not point onto the target. It is possible that in step D) the target is illuminated by the light source and/or by the picture recording arrangement exclusively in an indirect manner.

According to at least one embodiment, orientations of the light source's emission directions relative to the image sensor are fixed. That is, the emission directions do not vary their orientation relative to one another and relative to the image sensor.

According to at least one embodiment, a diameter of the light source is at most 0.3 m or is at most 0.2 m or is at most 8 cm or is at most 4 cm, seen in top view of the image sensor. Thus, the light source has, for example, lateral dimensions smaller than that of a mobile phone.

According to at least one embodiment, in step B) for each one of the emission directions exactly one calibration picture is taken, and per calibration picture exactly one of the emission directions is served by the light source. Thus, there is the same number of emission directions and calibration pictures, or there are p times as many calibration pictures than emission directions wherein p is a natural number greater than one and smaller than or equal to six. In particular, p=3.

According to at least one embodiment, step C) comprises:
C1) Taking a low-light image of the target with the light source being switched off. That is, illumination conditions of the low-light image are comparably bad.

According to at least one embodiment, step C) comprises:
C2) Creating a boosted image by numerically boosting a brightness of the low-light image. A boost factor for doing so can be pre-defined and may thus be a fixed value, or the boost factor can be a user input. It is possible that a small number of appropriate boost factors are automatically suggested by the picture recording arrangement to the user so that the user can choose the boost factor in a simplified manner. However, preferably the boost factor is determined automatically by the picture recording arrangement.

According to at least one embodiment, the objective function comprises a metric, like an L2 norm, between the boosted image and a composite image composed of all or some or a majority of the calibration pictures. Thus, the calibration pictures are overlaid to create the composite image by using the weight vector, and the optimized weight vector is chosen in particular so that there is a minimum possible difference between the composite image and the boosted image.

According to at least one embodiment, step C) comprises:
C3) Providing a reference image. The reference image can be an image taken independently of the method described herein. Thus, there does not need to be any spatial and/or temporal connection between the location and time the reference image has been generated and the location and time the method is performed. For example, the reference image is an image downloaded from the internet, an image shared by another user, a picture taken from a movie or also a graphic generated by a computer or by another user. Hence, in principle the reference image can arbitrarily be chosen.

According to at least one embodiment, step C) comprises:
C4) Computing a spherical harmonic representation of a reference ambient light distribution of the reference image. In other words, the illumination conditions present in the reference image are analyzed.

According to at least one embodiment, step C) comprises:
C5) Computing a same spherical harmonic representation of a linear combination of at least some of the calibration pictures, the objective function comprises a metric between the two spherical harmonic representations. In other words, the illumination conditions of the composite image can be analyzed in the same way as in case of the reference image. The weight vector is optimized to resemble the illumination conditions of the reference image as good as possible with the light source. In this case, the light along the emission directions can be colored light, in particular RGB light, so that three color channels may be taken into consideration per emission direction for the optimization.

According to at least one embodiment, an emission angle between an optical axis of the image sensor and all or a majority or some of the emission directions is at least 30° or is at least 45° or is at least 55°. Alternatively or additionally, this angle is at most 75° or is at most 70° or is at most 65°. Said angle may refer to a direction of maximum intensity of the respective emission direction.

According to at least one embodiment, for all or a majority or some of the emission directions an emission angle width per emission direction is at least 15° or is at least 25°. Alternatively or additionally, said angle is at most 45° or is at most 35°. Said angle may refer to a full width at half maximum, FWHM for short.

It is possible that the same emission parameters apply for all the emission directions or that the emission parameters differ between the emission directions.

According to at least one embodiment, the radiation emitted into the emission directions is emitted out of a field of view of the image sensor. That is, the radiation does not provide direct lighting of the target to be photographed.

According to at least one embodiment, there are at least six or at least 10 or at least 12 of the emission directions. Alternatively or additionally, there are at most 30 or at most 20 or at most 18 of the emission directions. For example, the number of emission directions is between 12 and 16 inclusive.

According to at least one embodiment, the light source comprises one light-emitting unit for each one of the emission directions. The light-emitting unit can be an emitter with one fixed emission characteristics or can also be an emitter with adjustable emission characteristics, like an RGB emitter, for example. It is possible that all light-emitting units are of the same construction, that is, of the same emission characteristics, or that there are light-emitting units with intentionally different emission characteristics.

According to at least one embodiment, positions of the light-emitting units relative to one another are fixed. That is, the light-emitting units cannot be moved relative to one another in intended use of the picture recording arrangement. Further, the light-emitting units can preferably not be moved relative to the image sensor in intended use of the picture recording arrangement.

According to at least one embodiment, the light-emitting units are arranged in a circular manner, seen in top view of the image sensor. For example, the image sensor may be arranged within the circle the light-emitting units are arranged on. The emission directions can be oriented inwards.

According to at least one embodiment, the light source comprises an additional light-emitting unit configured for direct lighting of the target. It is possible that said additional light-emitting unit is used in other situations and/or applications than the light-emitting units for indirect lighting. Hence, it is possible that both direct and indirect lighting may be addressed with the picture recording arrangement.

According to at least one embodiment, the method is performed indoor. Thus, the intended use case is in rooms and not in the open environment, in particular not in natural day light.

According to at least one embodiment, in step D) the light source emits a photo flash. Optionally, the light source can be configured for short-time or continuous lighting as well.

According to at least one embodiment, a distance between the picture recording arrangement and the target is at least 0.3 m or is at least 1 m. Alternatively or additionally, said distance is at most 10 m or is at most 6 m or is at most 3 m. In other words, the picture recording arrangement and the target are intentionally relatively close to one another.

According to at least one embodiment, the light source is configured to independently emit a plurality of beams having different colors along all or some or a majority of the emission directions. Thus, RGB light may be provided.

According to at least one embodiment, the light source is configured to emit only a single beam of light along at least some of the emission directions. Thus, the light source can have a single, fix color to be emitted. In this case, ‘color’ may refer to a specific coordinate in the CIE color table.

According to at least one embodiment, the light source comprises one or a plurality of emitters for non-visible radiation, like near-IR radiation. It is possible that there is only one common emitter for non-visible radiation or that there is one emitter for non-visible radiation per emission direction.

According to at least one embodiment, the picture recording arrangement comprises a 3D-sensor. By means of the 3D-sensor, the picture recording arrangement can obtain three-dimensional information of the scene, for example, prior to step C). The 3D-sensor can be, for example, based on a stereo camera set-up, on a time-of-flight set-up or on a reference pattern analyzing set-up.

According to at least one embodiment, the picture recording arrangement is a single device, like a single mobile device, including the image sensor as well as the light source and optionally the at least one additional light-emitting unit, the at least one emitter for non-visible radiation and/or the at least one 3D-sensor.

According to at least one embodiment, the picture recording arrangement is a mobile phone, like a smart phone.

Thus, in one embodiment the method may be summarized as follows:
Take, for example, one picture per emission direction, in which only the corresponding light-emitting unit is turned on and the others are turned off.
Choose an arbitrary distribution for the weights, for example, all weights equal to one which means all light-emitting units at full power. Set of weights is called the weight vector.
Optimize the weight vector with a gradient descent algorithm. The gradient descent is an iterative optimization algorithm that will refine the weight vector by running, for example, the following optimization sequence a certain number of times:
Slightly change the weight vector.
Numerically combine the images according to their weight.
Run an objective function, like a loss function, that returns a numerical value telling if the result image is good or not.
Back-propagate a loss gradient to evaluate the next change to apply to the weight vector, in particular if the loss was improved by the last change, keep changing the weight vector in that direction, otherwise try a different one.
Once the optimal weight vector has been found, apply the weights to the emission direction and take the target image.

The objective function, or loss function, can differ depending on the result desired to be achieved.

A picture recording arrangement is additionally provided. The picture recording arrangement is controlled by means of the method as indicated in connection with at least one of the above-stated embodiments. Features of the picture recording arrangement are therefore also disclosed for the method and vice versa.

In at least one embodiment, the picture recording arrangement is a mobile device and comprises an image sensor, a light source and a processing unit, wherein
the light source is configured to illuminate a scene comprising a target along different emission directions,
the image sensor is configured to take at least one calibration picture for each one of the emission directions, wherein per calibration picture the light source is configured to emit radiation only along a subset of the emission directions,
the processing unit is configured to generate an optimized weight vector by minimizing an objective function, the optimized weight vector includes at least one intensity value for each one of the emission directions, and
the image sensor and the processing unit are further configured to take at least one target image of the target by controlling light emission of the light source along the emission directions according to the optimized weight vector.

### BRIEF DESCRIPTION OF THE DRAWINGS

A method and a picture recording arrangement described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

FIG. 1 shows a schematic side view of an exemplary embodiment of a method using a picture recording arrangement described herein;

FIG. 2 shows a schematic front view of the method of FIG. 1;

FIG. 3 shows a schematic block diagram of an exemplary embodiment of a method described herein;

FIGS. 4 and 5 show schematic representations of method steps of an exemplary embodiment of a method described herein;

FIG. 6 show a schematic representation of the emission characteristics of a light-emitting unit for exemplary embodiments of picture recording arrangements described herein;

FIGS. 7 and 8 show schematic top views of exemplary embodiments of picture recording arrangements described herein; and

FIGS. 9 and 10 are schematic sectional views of light-emitting units for exemplary embodiments of picture recording arrangements described herein.

### DETAILED DESCRIPTION OF ILLUSTRATIVE EMBODIMENTS

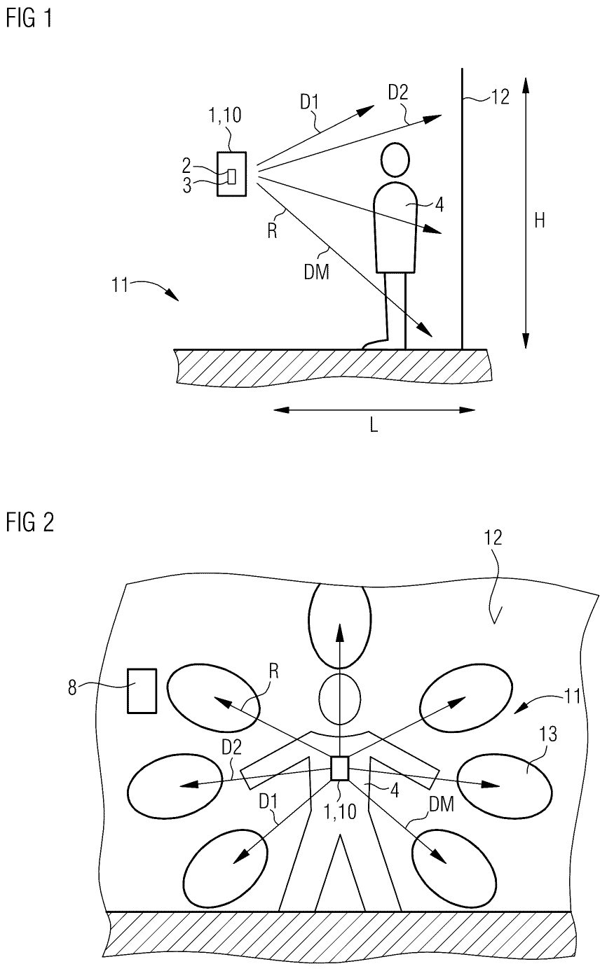

FIGS. 1 and 2 illustrate an exemplary embodiment of a method using a picture recording arrangement 1. The picture recording arrangement 1 is a mobile device 10 and comprises an image sensor 2 configured to take photos and/or videos. Further, the picture recording arrangement 1 comprises a light source 3. A user of the picture recording arrangement 1 is not shown in FIGS. 1 and 2.

In the intended use, the picture recording arrangement 1 is used indoors to take, for example, a target image IT of a target 4 in a scene 11. For example, the target 4 is a person to be photographed. For example, a distance L between the target 4 and the picture recording arrangement 1 is between 1 m and 3 m. It is possible that a size H of the target 4 is about 1 m to 2 m. The target 4 can be located in front of a wall 12 or any other item, for example, in front of the target 4 that provides a bouncing surface on the sides of the target 4 so that indirect lighting can be provided. The target 4 can be directly at the wall or can have some distance to the wall 12.

The light source 3 is configured to emit radiation R, like visible light and/or infrared radiation, along a plurality of emission directions D1 . . . DM. Thus, there are M emission directions. For example, M is between ten and 20 inclusive. By means of the light source 3, for example, for each one of the emission directions D1 . . . DM one illuminated area 13 is present next to the target 4 out of a field of view of the image sensor 2. Thus, the light source 3 provides indirect lighting. The emission of radiation along the emission directions D1 . . . DM can be adjusted by means of a processing unit of the picture recording arrangement 1.

For example, in the room the picture recording arrangement 1 and the target 4 are located there is a luminaire 8 that provides weak lighting. This mood provided by the luminaire 8 shall be reproduced by the picture recording arrangement 1. In order to do so and realizing a high picture quality, the light source 3 addresses, for example, in particular the illumination areas 13 being about in the same orientation relative to the target 4 as the luminaire 8. In FIG. 2, this would be, for example, the illumination areas 13 in the upper left area next to the luminaire 8. In this simple example, the mood can be kept while good illumination conditions can be present when taking the picture by having the light source 3 as an adapted photo flash.

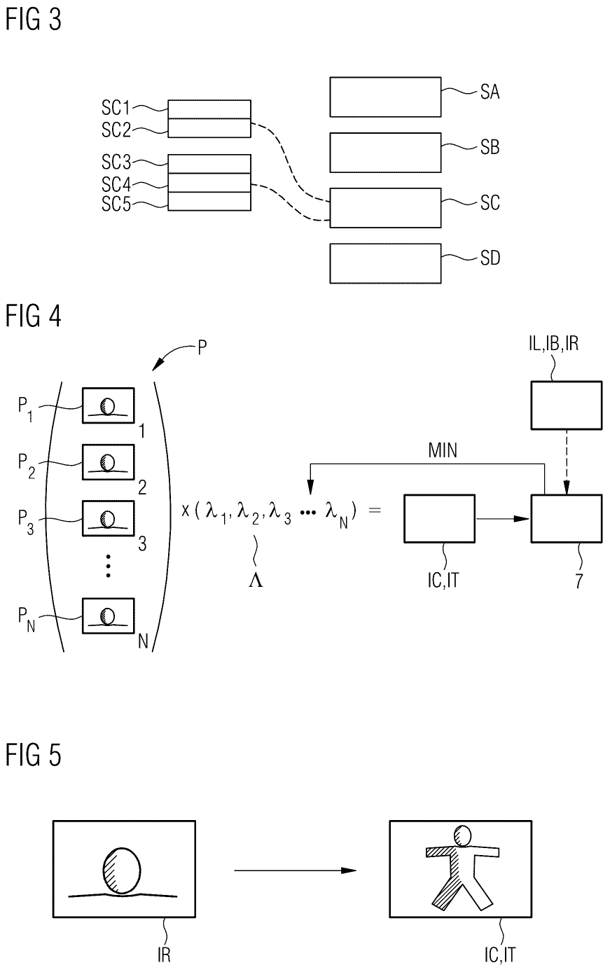

An example of the method to achieve this is schematically illustrated in connection with FIG. 3.

In method step SA, the picture recording arrangement 1 comprising the image sensor 2 and the light source 3 is provided, the light source 3 is configured to illuminate the scene 11 comprising the target 4 along the different emission directions D1 . . . DM.

In method step SB, at least one calibration picture P1 . . . PN is taking for each one of the emission directions D1 . . . DM, wherein per calibration picture P1 . . . PN the light source 3 emits radiation R only along a subset of the emission directions D1 . . . DM. Thus, a series of calibration pictures P1 . . . PN is produced with at least one or exactly one selected emission direction D1 . . . DM is served by the light source 3 per calibration picture P1 . . . PN.

In method step SC, an optimized weight vector ∧ is generated by minimizing an objective function f, the optimized weight vector ∧ includes at least one intensity value λ for each one of the emission directions D1 . . . DM. In other words, for example, a linear combination of the calibration pictures P1 . . . PN is produced by means of the optimized weight vector ∧ so that the objective function f, which may be a loss function, is as small as possible. One option to do so is explained in more detail in connection with FIG. 4 below.

In method step SD, at least one target image IT of the target 4 is taken by controlling light emission of the light source 3 along the emission directions D1 . . . DM according to the optimized weight vector ∧. In other words, for example, a photo flash is emitted by serving the emission directions D1 . . . DM as previously calculated.

Optionally, method step SC includes a method step SC1 in which a low-light image IL of the target 4 is taken with the light source 3 being switched off. That is, the target 4 is illuminated only with the light present in the scene 11 without the picture recording arrangement 1.

Optionally, method step SC includes a method step SC2 in which a boosted image IB is created by numerically boosting a brightness of the low-light image IL, the objective function f comprises a metric between the boosted image IB and a composite image IC composed of at least some of the calibration pictures P1 . . . PN. This is explained in more detail also in connection with FIG. 4 below.

Preferably, both method steps SC1 and SC2 are performed.

Optionally, method step SC includes a method step SC3 in which a reference image IR is provided. Further, then preferably the method step SC also comprises a method step SC4 in which a spherical harmonic representation of a reference ambient light distribution of the reference image IR is computed. Moreover, then preferably the method step SC also comprises a method step SC5 in which a same spherical harmonic representation of a linear combination of at least some of the calibration pictures P1 . . . PN is computed, the objective function f comprises a metric between the two spherical harmonic representations. This is explained also in connection with FIG. 5 below.

In the example of FIG. 4, a calibration vector P is created which is composed of the N calibration pictures P1 . . . PN. For example, per calibration picture P1 . . . PN exactly one of the emission directions D1 . . . DM is served, so that for each one of the directions D1 . . . DM there is one calibration picture P1 . . . PN. Hence, there can be N calibration pictures P1 . . . PN and N emission directions D1 . . . DM, but the method described herein is not limited thereto.

The calibration vector P is multiplied with a weight vector ∧ so that a composite image IC is created. The weight vector ∧ comprises at least one intensity value λ per emission direction. For example, in case N=M and in case of single-colored emission directions D1 . . . DM, there are N intensity values λ.

This composite image IC is compared with the objective function f. As an input, the objective function f has, for example, the low-light image IL, the boosted image IB and/or the reference image IR. It is possible that by means of the objective function f at least one parameter to be considered is extracted from the composite image IC, and that said at least one parameter is compared with at least one corresponding parameter taken form the input, that is, for example, from the boosted image IB and/or the reference image IR.

Then, the weight vector ∧ is varied, that is, optimized until the composite image IC leads to minimum possible differences, or near minimum possible differences between the goal to be achieved and the resulting linear combination of the calibration pictures P1 . . . PN. The corresponding optimized weight vector ∧ is used to then take the target image IT.

In FIG. 5 it is illustrated that the reference image IR is provided. Illumination conditions are analyzed and extracted from the reference image IR and can serve as an input or parameter set for the objective function f. This is symbolized in FIG. 5 by means of the indicated shading in the reference image IR.

Then, the linear combination of the calibration pictures P1 . . . PN is optimized to resemble these illumination conditions as much as possible. This is indicated by the shading in the composite image IC. Accordingly, the mood of the reference image IR can be transferred to the target image IT.

Preferably, in this case of mood transfer, the emission directions D1 . . . DM each have RGB channels so that there are possibly 3N calibration pictures if there are N emission directions. However, if color filtering can be done when taking the calibration pictures, N calibration pictures may be sufficient.

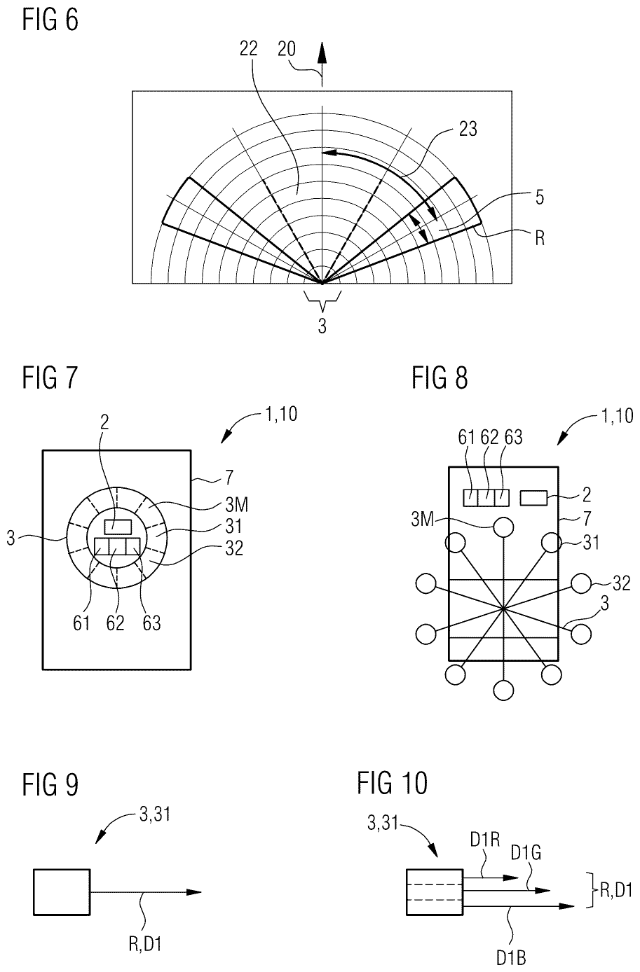

In FIG. 6, exemplary parameters of the emission directions D1 . . . DM are illustrated. For example, an angle 23 between an optical axis 20 of the image sensor 2 and the emission directions D1 . . . DM is about 60°. An emission angle width 5 of the emission directions D1 . . . DM may be about 30°in each case. Thus, no or virtually no radiation R is emitted by the light source 3 into the field of view 22 of the image sensor 2.

In FIGS. 7 and 8, exemplary embodiments of the picture recording arrangement 1 are shown. In both cases, the picture recording arrangement 1 is a mobile device 10, like a smartphone.

The light source 3 comprises a plurality of light-emitting units 31 . . . 3M. The light-emitting units 31 . . . 3M can be light-emitting diodes, LEDs for short. It is possible that the light-emitting units 31 . . . 3M are arranged in a circular manner, that is, on a circle. Because a distance between the light-emitting units 31 . . . 3M is very small compared with a distance between the illuminated areas 13, compare FIG. 2, it is not necessary that an arrangement order of the light-emitting units 31 . . . 3M corresponds to an arrangement order of the illuminated areas 13.

Hence, it is alternatively also possible for the light-emitting units 31 . . . 3M to be arranged in a matrix, for example.

If the light-emitting units 31 . . . 3M are arranged on a circle, it is possible that the respective emission directions D1 . . . DM associated with the light-emitting units 31 . . . 3M can point inwards, that is, can cross a center of the circle.

Moreover, the picture recording arrangement 1 includes the at least one image sensor 2. Optionally, the picture recording arrangement 1 can include at least one of an additional light-emitting unit 61, at least one emitter 62 for non-visible radiation or a 3D-sensor 63. Further, the picture recording arrangement 1 comprises a processing unit 7 configured to perform the method described above. The processing unit 7 can be a main board or an auxiliary board of the picture recording arrangement 1.

According to FIG. 7, the light source 3 is integrated in a casing of the picture recording arrangement 1. The light-emitting units 31 . . . 3M are arranged around the image sensor 2. Optionally, the at least one of the additional light-emitting unit 61, the emitter 62 for non-visible radiation or the 3D-sensor 63 can also be located within the arrangement of the light-emitting units 31 . . . 3M, seen in top view of the image sensor 2.

Other than shown in FIG. 7, the at least one of the additional light-emitting unit 61, the emitter 62 for non-visible radiation or the 3D-sensor 63 as well as the image sensor 2 can be located outside of the arrangement of the light-emitting units 31 . . . 3M. as illustrated in FIG. 8.

Moreover, in FIG. 8 it is shown that the light-emitting units 31 . . . 3M are arranged in a spider-like manner. In this case, the arrangement of the light-emitting units 31 . . . 3M can protrude from the casing, but it can also be completely within the casing, seen in top view of the image sensor 2 and other than shown in FIG. 8.

Thus, it is possible that the light-source 3 can be an external unit mounted, like clamped or glued, on the casing. An electrical connection between the casing and the light-source 3 can be done by a USB type C connection, for example.

Otherwise, the same as to FIGS. 1 to 6 may also apply to FIGS. 7 and 8, and vice versa.

In FIG. 9, one exemplary light-emitting unit 31 of the light source 3 is illustrated. In this case, the light-emitting unit 31 has only one channel, that is, is configured to emit along the assigned emission direction D1 with a fixed color, for example. Said color is white light, for example.

Contrary to that, according to FIG. 10 the light-emitting unit 31 comprises three color channels for red, green and blue light, for example. Thus, three beams D1R, D1G, D1B are emitted along the assigned emission direction D1 to form the radiation R. The three color channels are preferably electrically addressable independent of one another so that an emission color of the light-emitting unit 31 can be tuned. For example, each color channel is realized by an own LED chip as the respective light emitter.

The light-emitting units 31 of FIGS. 9 and 10 can be used in all embodiments of the picture recording arrangement 1, also in combination with each other.

Otherwise, the same as to FIGS. 1 to 8 may also apply to FIGS. 9 and 10, and vice versa.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

1-18. (canceled)

19. A method for adapting illumination comprising:
A) providing a picture recording arrangement comprising an image sensor and a light source, the light source being configured to illuminate a scene comprising a target along different emission directions;
B) taking at least one calibration picture for each one of the emission directions, wherein, per calibration picture, the light source emits radiation only along a subset of the emission directions;
C) generating an optimized weight vector by minimizing an objective function, the optimized weight vector including at least one intensity value for each one of the emission directions; and
D) taking at least one target image of the target by controlling light emission of the light source along the emission directions according to the optimized weight vector,
wherein, in step D), the target is illuminated in an indirect manner so that at least some of the emission directions point next to the target and not onto the target, and
wherein a diameter of the light source is at most 0.3 m, seen in top view of the images sensor.

20. The method according to claim 19,
wherein, in step D), the target is illuminated exclusively in an indirect manner, and
wherein orientations of the emission directions relative to the image sensor are fixed.

21. The method according to claim 19,
wherein, in step B), for each one of the emission directions, exactly one calibration picture is taken, and
wherein, per the calibration picture, exactly one of the emission directions is served by the light source.

22. The method according to claim 19, wherein step C) comprises:
C1) taking a low-light image of the target with the light source being switched off.

23. The method according to claim 22, wherein step C) further comprises:
C2) creating a boosted image by numerically boosting a brightness of the low-light image, the objective function comprising a metric between the boosted image and a composite image composed of at least some of the calibration pictures.

24. The method according to claim 19, wherein step C) comprises:
C3) providing a reference image,
C4) computing a spherical harmonic representation of a reference ambient light distribution of the reference image,
C5) computing the same spherical harmonic representation of a linear combination of at least some of the calibration pictures, the objective function comprising a metric between two spherical harmonic representations.

25. The method according to claim 19,
wherein an emission angle between an optical axis of the image sensor and at least some of the emission directions is between 30° and 75°, inclusive,
wherein, for at least some of the emission directions, an emission angle width per emission direction is between 15° and 45°, inclusive, and
wherein a radiation emitted into the emission directions is emitted out of a field of view of the image sensor.

26. The method according to claim 19, wherein the emission directions comprise at least six and at most 30.

27. The method according to claim 19,
wherein the light source comprises one light-emitting unit for each one of the emission directions,
wherein positions of the light-emitting units relative to one another are fixed, and
wherein the light-emitting units are arranged in a circular manner, seen in the top view of the image sensor.

28. The method according to claim 19, wherein the light source comprises an additional light-emitting unit configured for direct lighting of the target.

29. The method according to claim 19,
wherein the method is performed indoor,
wherein, in step D), the light source emits a photo flash, and
wherein a distance between the picture recording arrangement and the target is between 1 m and 6 m, inclusive.

30. The method according to claim 19, wherein the light source independently emits a plurality of beams having different colors along at least some of the emission directions.

31. The method according to claim 19, wherein the light source emits only a single beam of light along at least some of the emission directions.

32. The method according to claim 19, wherein the light source comprises emitters for non-visible radiation so that each one of the emission directions is equipped with at least one of the emitters for non-visible radiation.

33. The method according to claim 19,
wherein the picture recording arrangement comprises a 3D-sensor, and
wherein the 3D-sensor obtains three-dimensional information of the scene prior to step C).

34. The method according to claim 19, wherein the picture recording arrangement is a single mobile device having the image sensor as well as the light source.

35. The method according to claim 34, wherein the picture recording arrangement is a smart phone.

36. A mobile device comprising:
an image sensor;
a light source; and
a processor,
wherein the light source is configured to illuminate a scene comprising a target along different emission directions,
wherein the image sensor is configured to take at least one calibration picture for each one of the emission directions, wherein, per calibration picture, the light source is configured to emit radiation only along a subset of the emission directions,
wherein the processor is configured to generate an optimized weight vector by minimizing an objective function, the optimized weight vector including at least one intensity value for each one of the emission directions, and
wherein the image sensor and the processor are further configured to take at least one target image of the target by controlling light emission of the light source along the emission directions according to the optimized weight vector.

37. A method for adapting illumination comprising:
A) providing a picture recording arrangement comprising an image sensor and a light source, the light source being configured to illuminate a scene comprising a target along different emission directions;
B) taking at least one calibration picture of the scene for each one of the emission directions, wherein, per calibration picture, the light source emits radiation only along a subset of the emission directions;
C) generating an optimized weight vector by minimizing an objective function, the optimized weight vector includes at least one intensity value for each one of the emission directions; and
D) taking at least one target image of the target by controlling light emission of the light source along the emission directions according to the optimized weight vector,
wherein, in step D) the target is illuminated in an indirect manner so that at least some of the emission directions point next to the target and not onto the target,
wherein a diameter of the light source is at most 0.3 m, seen in top view of the images sensor,
wherein orientations of the emission directions relative to the image sensor are fixed,
wherein the light source comprises one light-emitting unit for each one of the emission directions,
wherein the light-emitting units of the light source are arranged in a circular manner or in a matrix, seen in the top view of the image sensor,
wherein the radiation emitted into the emission directions is emitted out of a field of view of the image sensor, and
wherein, step C) comprises:
C2) either creating a boosted image by numerically boosting a brightness of a low-light image, the objective function comprising a metric between the boosted image and a composite image composed of at least some of the calibration pictures, or
C3) providing a reference image, and
C4) computing a spherical harmonic representation of a reference ambient light distribution of the reference image, and
C5) computing the same spherical harmonic representation of a linear combination of at least some of the calibration pictures, the objective function comprising a metric between two spherical harmonic representations.
